(19) United States
(12) Patent Application Publication
(10) Pub. No.: US 2025/0252727 A1
(43) Pub. Date: Aug. 7, 2025

(54) THREE-DIMENSIONAL SEMANTIC SCENE GRAPH (3DSSG) GENERATION METHOD AND SYSTEM, AND ELECTRONIC DEVICE

(71) Applicants: University of Electronic Science and Technology of China, Chengdu (CN); Sichuan Digital Economy Research Institute (Yibin), Yibin (CN)

(72) Inventors: Ning XIE, Chengdu (CN); Tangsheng DAN, Chengdu (CN); Zheng WANG, Chengdu (CN); Sheng CAO, Chengdu (CN)

(73) Assignees: University of Electronic Science and Technology of China, Chengdu (CN); Sichuan Digital Economy Research Institute (Yibin), Yibin (CN)

(21) Appl. No.: 18/670,078

(22) Filed: May 21, 2024

(30) Foreign Application Priority Data
Feb. 4, 2024 (CN) 202410158104.9

(51) Int. Cl. G06V 10/86; G06V 10/26; G06V 10/77; G06V 10/774; G06V 10/82

(52) U.S. Cl. CPC G06V 10/86; G06V 10/26; G06V 10/7715; G06V 10/774; G06V 10/82

(57) ABSTRACT

The present disclosure provides a three-dimensional semantic scene graph (3DSSG) generation method and system, and an electronic device, and relates to the field of three-dimensional (3D) scene graph generation. The method includes: obtaining a point cloud set and an object segmentation result of a target scene; determining a point cloud subset of each object according to the point cloud set and the object segmentation result; and determining a 3DSSG of the target scene according to a point cloud subset of any object and object auxiliary information by using a 3DSSG prediction model, where the 3DSSG prediction model is obtained by training a 3DSSG initial prediction model by using a training dataset; and the 3DSSG prediction model includes a Transformer-based feature extractor, a first multi-layer perceptron (MLP), a graph neural network (NN)-based relationship reasoning module, and a scene graph generation module. The present disclosure improves accuracy of generating a 3DSSG.

### CROSS REFERENCE TO RELATED APPLICATION

This patent application claims the benefit and priority of Chinese Patent Application No. 2024101581049, filed with the China National Intellectual Property Administration on Feb. 4, 2024, the disclosure of which is incorporated by reference herein in its entirety as part of the present application.

### TECHNICAL FIELD

The present disclosure relates to the field of three-dimensional (3D) scene graph generation, and in particular, to a three-dimensional semantic scene graph (3DSSG) generation method and system, and an electronic device.

### BACKGROUND

Scene understanding is a basic task in the field of computer vision, and is widely used in multiple fields, such as a robot and virtual reality (VR). To understand a 3D scene, a classification and positioning of each object, and a complex internal structure and semantic relationship need to be accurately identified.

A scene graph is a data structure used to describe a scene structure, and is an important tool for completing a scene understanding task in the fields of computer vision and graphics. In computer graphics, the scene graph is usually used in a 3D game, VR, augmented reality (AR), and another virtual interaction environment, to describe information such as an object, a light source, a material, and the like in a scene. In the computer vision, the scene graph is usually used for tasks such as image classification, target detection, and image segmentation.

The concept of scene graph originates from computer graphics research, is later used in the computer vision, and becomes an important tool for the scene understanding task. In the field of computer vision, scene graph generation based on a two-dimensional (2D) image is relatively sufficiently studied.

At the Institute of Electrical and Electronics Engineers (IEEE) International Conference on Computer Vision (ICCV) in 2019, Iro Armeni et al. migrated a scene graph research method to 3D space for the first time. This technology attracts some attention both in the field of computer vision and in the field of computer graphics. However, in recent years, with emergence of a 3DSSG dataset, a research topic of 3D scene graph generation gradually attracts attention, for example, a Scene Graph Fusion Network (SGPN) proposed in the conference on Computer Vision and Pattern Recognition (CVPR) in 2019, and Spatial-Gate Feed-forward Network (SGFN) and point-based scene graph generation (SGGpoint) methods proposed in 2021. A 3D scene graph generation technology has potential to enable a computer to further perceive a real world, and has considerable application potential in fields such as a robot, 3D scene retrieval, picture/video motion capture, special relationship detection, and VR/AR.

The 3D scene graph generation technology is a new technology that combines multiple methods such as point cloud feature extraction, a graph type data structure, and deep learning. There is considerable research and optimization space in a point cloud feature extraction algorithm, method optimization based on a graph theory, and a machine learning method. In addition, prediction accuracy of a current advanced model for an object can only reach about 50%. Currently, research in the field of a 3D scene graph mainly focuses on improving a graph convolution module and integrating other modal information.

### SUMMARY

The present disclosure aims to provide a 3DSSG generation method and system, and an electronic device, to improve accuracy of generating a 3DSSG.

To achieve the above objective, the present disclosure provides the following technical solutions.

A 3DSSG generation method includes:
obtaining a point cloud set and an object segmentation result of a target scene, where the target scene includes multiple objects;
determining a point cloud subset of each object according to the point cloud set and the object segmentation result; and
determining a 3DSSG of the target scene according to a point cloud subset of any object and object auxiliary information by using a 3DSSG prediction model, where the object auxiliary information includes a bounding box size of the point cloud subset, an object length, an object volume, and an object point cloud spatial distribution standard deviation (SD); the 3DSSG prediction model is obtained by training a 3DSSG initial prediction model by using a training dataset; the training dataset is a 3DSSG dataset; the 3DSSG prediction model includes a Transformer-based feature extractor, a first multi-layer perceptron (MLP), a graph neural network (NN)-based relationship reasoning module, and a scene graph generation module; both the Transformer-based feature extractor and the first MLP are connected to the graph NN-based relationship reasoning module; and the graph NN-based relationship reasoning module is connected to the scene graph generation module.

Optionally, the determining a 3DSSG of the target scene according to a point cloud subset of any object and object auxiliary information by using a 3DSSG prediction model specifically includes:
determining an object feature of the any object according to the point cloud subset of the any object and the object auxiliary information by using the Transformer-based feature extractor, where the Transformer-based feature extractor includes a second MLP, a first Transformer module, a downsampling layer, and a second Transformer module that are connected in sequence;
determining an object relationship feature according to a point cloud subset of a source object and a point cloud subset of a target object by using the first MLP, where the source object and the target object are two related objects in the target scene;
updating the object feature and the object relationship feature by using the graph NN-based relationship reasoning module, to obtain an updated object feature and an updated object relationship feature, where the graph NN-based relationship reasoning module includes a relationship feature updating module and an object feature updating module; the relationship feature updating module is a third MLP; and the object feature updating module is an attention network (AttnNet); and
determining the 3DSSG of the target scene according to the updated object feature and the updated object relationship feature by using the scene graph generation module, where the scene graph generation module includes a first linear layer, a first batch normalization layer, a first rectified linear unit (Relu) activation function layer, a second linear layer, a second batch normalization layer, a second Relu activation function layer, and a third linear layer that are connected in sequence.

Optionally, the first Transformer module includes a fourth linear layer, a first Transformer layer, and a fifth linear layer that are connected in sequence.

Optionally, the second Transformer module includes a sixth linear layer, a second Transformer layer, and a seventh linear layer that are connected in sequence.

Optionally, the AttnNet includes a sixth linear layer, a seventh linear layer, an eighth linear layer, a fourth MLP, a softmax function layer, and a fifth MLP; and
both the sixth linear layer and the seventh linear layer are connected to the fourth MLP; the fourth MLP is connected to the softmax function layer; and both the softmax function layer and the eighth linear layer are connected to the fifth MLP.

A 3DSSG generation system includes:
a data obtaining module configured to obtain a point cloud set and an object segmentation result of a target scene, where the target scene includes multiple objects;
an object point cloud subset determining module configured to determine a point cloud subset of each object according to the point cloud set and the object segmentation result; and
a scene graph prediction module configured to determine a 3DSSG of the target scene according to a point cloud subset of any object and object auxiliary information by using a 3DSSG prediction model, where the object auxiliary information includes a bounding box size of the point cloud subset, an object length, an object volume, and an object point cloud spatial distribution SD; the 3DSSG prediction model is obtained by training a 3DSSG initial prediction model by using a training dataset; the training dataset is a 3DSSG dataset; the 3DSSG prediction model includes a Transformer-based feature extractor, a first MLP, a graph NN-based relationship reasoning module, and a scene graph generation module; both the Transformer-based feature extractor and the first MLP are connected to the graph NN-based relationship reasoning module; and the graph NN-based relationship reasoning module is connected to the scene graph generation module.

An electronic device includes a memory and a processor, the memory is configured to store a computer program, and the processor runs the computer program to enable the electronic device to perform the foregoing 3DSSG generation method.

Optionally, the memory is a readable storage medium.

According to specific embodiments provided in the present disclosure, the present disclosure has the following technical effects:

The present disclosure provides a 3DSSG generation method and system, and an electronic device. The method includes: obtaining a point cloud set and an object segmentation result of a target scene, where the target scene includes multiple objects; determining a point cloud subset of each object according to the point cloud set and the object segmentation result; and determining a 3DSSG of the target scene according to a point cloud subset of any object and object auxiliary information by using a 3DSSG prediction model, where the 3DSSG prediction model is obtained by training a 3DSSG initial prediction model by using a training dataset; and the 3DSSG prediction model includes a Transformer-based feature extractor, a first MLP, a graph NN-based relationship reasoning module, and a scene graph generation module. In the present disclosure, relationships between names of all objects and the objects in the target scene are predicted by using the 3DSSG prediction model, and a structured 3DSSG is finally generated, thereby improving accuracy of generating the 3DSSG.

### BRIEF DESCRIPTION OF THE DRAWINGS

To describe the technical solutions in embodiments of the present disclosure or in the conventional technology more clearly, the accompanying drawings required in the embodiments are briefly described below. Apparently, the accompanying drawings in the following description show merely some embodiments of the present disclosure, and other drawings can be derived from these accompanying drawings by those of ordinary skill in the art without creative efforts.

FIG. 1 is a flowchart of a 3DSSG generation method according to the present disclosure;

FIG. 2 is an overall schematic diagram of a 3DSSG generation method according to the present disclosure;

FIG. 3 is a schematic structural diagram of a Transformer-based feature extractor according to the present disclosure;

FIG. 4 is a schematic structural diagram of a Transformer module according to the present disclosure;

FIG. 5 is a schematic structural diagram of a Transformer layer according to the present disclosure;

FIG. 6 is a schematic structural diagram of a downsampling layer according to the present disclosure;

FIG. 7 is a schematic structural diagram of a graph NN-based relationship reasoning module according to the present disclosure; and

FIG. 8 is a schematic structural diagram of a scene graph generation module according to the present disclosure.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. All other embodiments obtained by those skilled in the art based on the embodiments of the present disclosure without creative efforts shall fall within the protection scope of the present disclosure.

The present disclosure aims to provide a 3DSSG generation method and system, and an electronic device, to improve accuracy of generating a 3DSSG.

A 3DSSG generation task is defined as: giving a real 3D scene, identifying all object instances from the given real 3D scene, predicting all objects and a semantic classification label of a relationship between the objects, and finally generating a structured semantic scene graph. The scene graph is a data structure obtained by abstracting the 3D scene, and also supports visualization, which can assist humans and computers in understanding the 3D scene.

To make the above objective, features, and advantages of the present disclosure clearer and more comprehensible, the present disclosure will be further described in detail below in combination with accompanying drawings and specific implementations.

### Embodiment 1

Based on a point set P and an object segmentation result M of a given scene s, a scene graph G can be generated according to the method. The point set P and the object segmentation result M of the scene s are obtained by using an existing mature laser scanning technology and an object segmentation algorithm. Specifically, the given point cloud P∈R^{N} includes N 3D points, and a group of object masks M={M₁, . . . , M_{K}}represent K semantic objects in the point cloud P. This method aims to predict a 3DSSG G=(N, E), where N represents object nodes, and E represents a relationship between the nodes.

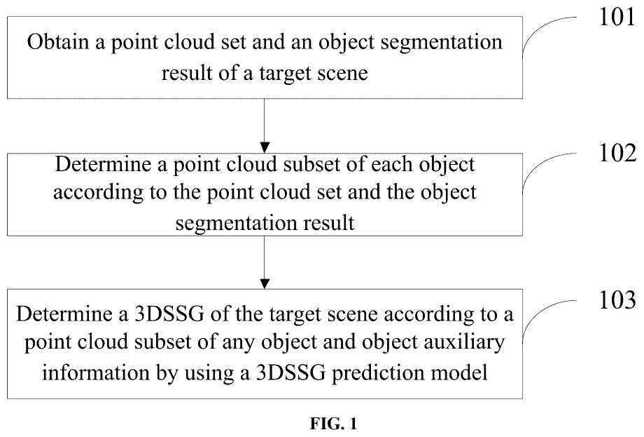

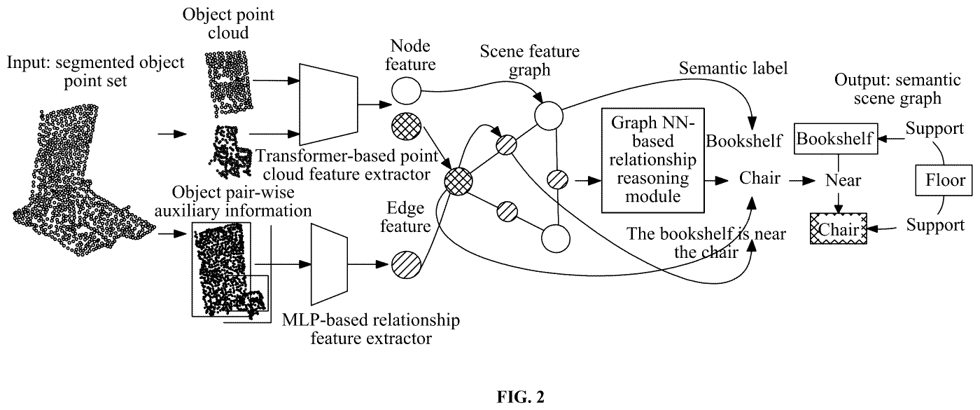

As shown in FIG. 1 and FIG. 2, the 3DSSG generation method provided in the present disclosure includes the following steps.

Step 101: Obtain a point cloud set and an object segmentation result of a target scene, where the target scene includes multiple objects.

In actual application, based on the point set (point cloud set) P and the object segmentation result M of the given scene (target scene) s, the 3DSSG G can be generated according to the present disclosure. The point set P and the object segmentation result M of the given scene s are obtained by using the existing mature laser scanning technology and the object segmentation algorithm. Specifically, the point set P∈R^{N} includes N 3D points, and object masks (the object segmentation result) M={M₁, . . . , M_{K}}represent K semantic objects in the point cloud P. The present disclosure aims to predict a 3DSSG G=(N, E), where N represents object nodes, and E represents a relationship between the nodes.

Step 102: Determine a point cloud subset of each object according to the point cloud set and the object segmentation result.

Step 103: Determine a 3DSSG of the target scene according to a point cloud subset of any object and object auxiliary information by using a 3DSSG prediction model, where the object auxiliary information includes a bounding box size of the point cloud subset, an object length, an object volume, and an object point cloud spatial distribution SD; the 3DSSG prediction model is obtained by training a 3DSSG initial prediction model by using a training dataset; the training dataset is a 3DSSG dataset; the 3DSSG prediction model includes a Transformer-based feature extractor, a first MLP, a graph NN-based relationship reasoning module, and a scene graph generation module; both the Transformer-based feature extractor and the first MLP are connected to the graph NN-based relationship reasoning module; and the graph NN-based relationship reasoning module is connected to the scene graph generation module.

In actual application, for a real 3D scene (the target scene), the point set P of the scene is obtained by using the laser scanning technology, and the object segmentation result M is obtained by using the mature object segmentation algorithm. To obtain the 3DSSG G from the point cloud of the scene, to complete a semantic understanding task of the 3D scene, the following four steps are divided.

S1: Determine an object feature of the any object according to the point cloud subset of the any object and the object auxiliary information by using the Transformer-based feature extractor, where the Transformer-based feature extractor includes a second MLP, a first Transformer module, a downsampling layer, and a second Transformer module that are connected in sequence. The first Transformer module includes a fourth linear layer, a first Transformer layer, and a fifth linear layer that are connected in sequence. The second Transformer module includes a sixth linear layer, a second Transformer layer, and a seventh linear layer that are connected in sequence.

In actual application, object feature extraction is performed by using the Transformer-based feature extractor.

For the 3D scene, a point set (the point cloud subset) Pᵢ of each object is extracted according to the point set P and the object segmentation mask M. The point set is encoded by using the Transformer-based feature extractor fₚ( ), to output an implicit feature with object geometry information. To better use information about the object in the 3D scene, four pieces of auxiliary information, including a bounding box size bᵢ of each object point set, an object length lᵢ, an object volume volᵢ, and an object point cloud spatial distribution SD σᵢ, are added together to an object feature to obtain an object feature vᵢ, and the feature is finally used for semantic recognition of the object. A formula is as follows:

$${v}_{i} [ {f}_{p} ( {P}_{i} ) , {σ}_{i} , ln ( {b}_{i} ) , ln ( {vol}_{i} ) ln ( {1}_{1} )$$

[ ] represents a concatenation operation. The function fₚ( ) is described later in this section.

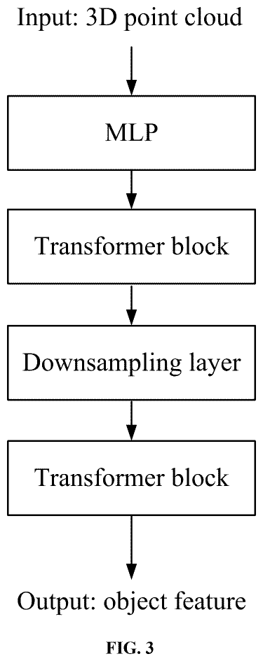

In the present disclosure, a point cloud feature is extracted by using a Transformer network structure, and a point cloud feature downsampling method of a PointNet++ style is combined, to implement an attention mechanism in object point cloud feature extraction. A structure of the Transformer-based feature extractor is shown in FIG. 3.

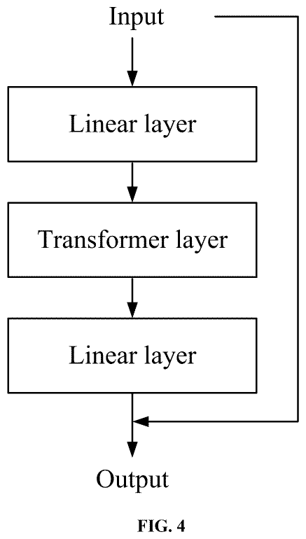

In the object feature extraction in the present disclosure, a Transformer block (a Transformer module) with a point Transformer layer as a core is constructed. As shown in FIG. 4, the Transformer block integrates a self-attentive layer, and a linear connection layer that can reduce a feature dimension and accelerate data processing, and uses a residual connection method to retain global information to a greater extent.

The Transformer layer is a core of the Transformer module, and a main function of the Transformer layer is to define and implement a self-attention operation. For each Transformer layer, an input dimension is equal to an output dimension. The module uses a point set as a smallest unit of calculation performed by a self-attention module. For an i^{th} point in the point set, and a self-attention operation result of the i^{th} point is:

$${f}_{p} ( {P}_{i} ) = {\sum }_{{x}_{j} ∈ {X}_{( i )}} ρ ( γ ( φ ( {P}_{i} ) - ψ ( {x}_{j} ) + δ ) ) ⊙ ( α ( {x}_{j} ) + δ )$$

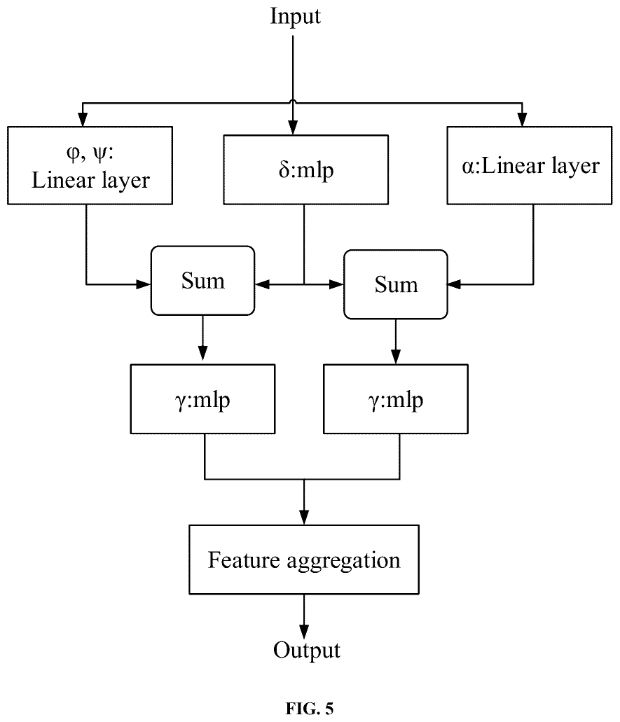

The set X₍ᵢ₎ herein is all feature points in a k-nearest neighbor of Pᵢ. φ, ψ, and α are all point-by-point feature transformation, δ is a position coding function, and the four are implemented by using a linear layer. The function γ is an MLP with two linear layers and one ReLU activation function. A specific structure is shown in FIG. 5.

An input of the module is a feature vector set x with associated 3D coordinates (which belongs to a same local group). The Transformer layer facilitates information exchange between these local feature vectors, to generate a new feature vector as an output of the Transformer layer.

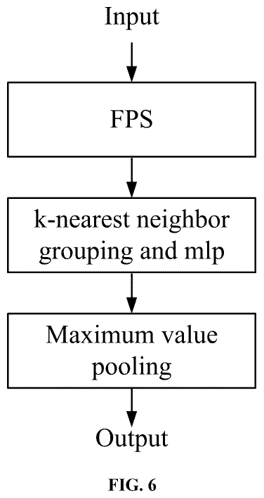

The downsampling layer in the Transformer-based feature extractor includes farthest point sampling (FPS), k-nearest neighbor grouping, and a maximum value pooling module. A detailed structure is shown in FIG. 6. An FPS method refers to a technique for selecting a sample with a maximum average distance in a dataset. The method ensures a more uniform spatial distribution of selected samples by calculating a distance between each sample and a selected sample and selecting a sample with a largest average distance from an existing sample. The k-nearest neighbor grouping refers to a data clustering algorithm based on a nearest neighbor distance, and the k-nearest neighbor grouping aims to divide a dataset (the point cloud set in the present disclosure) into clusters with similar features. Feature data of each cluster is aggregated by using an MLP algorithm and a maximum value pooling algorithm, to complete downsampling of 3D point cloud data.

S2: Determine an object relationship feature according to a point cloud subset of a source object and a point cloud subset of a target object by using the first MLP, where the source object and the target object are two related objects in the target scene.

In actual application, object relationship feature extraction is performed by using an MLP-based algorithm (the first MLP).

In a 3D point cloud scene, for a semantic relationship between objects, feature extraction is performed based on point clouds of two related objects: giving a source object node i and a target object node j, where i≠j. In this case, a calculation manner of an object relationship feature eᵢⱼ is as follows:

$${e}_{ij} = {g}_{s} ( [ {p}_{i} - {p}_{j} , {σ}_{i} - {σ}_{j} , {b}_{i} - {b}_{j} , ln ( \frac{{1}_{i}}{{1}_{j}} ) , ln ( \frac{{vol}_{i}}{{vol}_{j}} ) ) ]$$

gₛ( ) refers to a feature extractor (the first MLP) proposed in a PointNet; bᵢ and bⱼ respectively represent a bounding box size of the source object and a bounding box size the target object; lᵢ and lⱼ respectively represent an object length of the source object and an object length of the target object; vᵢ and vⱼ respectively represent an object volume of the source object and an object volume of the target object; σᵢ and σⱼ respectively represent an object point cloud spatial distribution SD of the source object and an object point cloud spatial distribution SD of the target object; and pᵢ and pⱼ respectively represent center point coordinates of the source object and center point coordinates of the target object. The network (the first MLP) extracts a feature from the object auxiliary information in the dataset, and projects relationship information between the objects into implicit feature space, to further process and perform semantic recognition on the information in subsequent steps.

S3: Update the object feature and the object relationship feature by using the graph NN-based relationship reasoning module, to obtain an updated object feature and an updated object relationship feature, where the graph NN-based relationship reasoning module includes a relationship feature updating module and an object feature updating module; the relationship feature updating module is a third MLP; and the object feature updating module is an AttnNet. The AttnNet includes a sixth linear layer, a seventh linear layer, an eighth linear layer, a fourth MLP, a softmax function layer, and a fifth MLP; both the sixth linear layer and the seventh linear layer are connected to the fourth MLP; the fourth MLP is connected to the softmax function layer; and both the softmax function layer and the eighth linear layer are connected to the fifth MLP.

In actual application, the object feature vᵢ obtained in S1 and the object relationship feature eᵢⱼ obtained in S2 are processed, to enable the object feature and the object relationship feature to influence and promote each other, to obtain a new object feature and a new object relationship feature, thereby achieving further semantic understanding of the 3D point cloud scene.

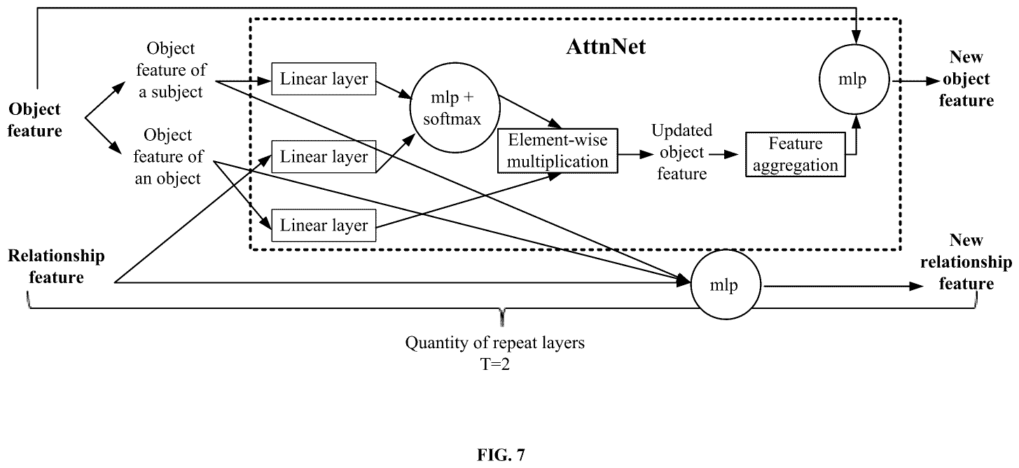

The overall framework of the graph NN-based relationship reasoning module is shown in FIG. 7. For a node feature (the object feature), forward propagation as shown in the formula is implemented at each information transfer layer 1:

$${v}_{i}^{l + 1} = {g}_{V} ( [ {v}_{i}^{l} {, max}_{j ∈ {N}_{( i )}} ( AttnNet ( {v}_{i}^{l} , {e}_{ij}^{l} , {v}_{j}^{l} ) ) ] )$$

gᵥ( ) refers to an MLP module; N₍ᵢ₎ is an adjacent node set of a node i; vᵢ^{l} represents an object feature of the source object at an l^{th} layer; vᵢ^{l+1} represents an object feature of the source object at an (1+1)^{th} layer; a function AttnNet( ) is an attention mechanism network used in the present disclosure; eᵢⱼ^{l} represents an object relationship feature of the source object and the target object at the l^{th} layer; and vⱼ^{l} represents an object feature of the target object at the l^{th} layer.

This forward propagation mechanism implements a node feature update manner in which for each node, a<subject-relationship-object> triple formed by the node and all adjacent nodes is considered, and a feature triple {vᵢ, eᵢⱼ, vⱼ}corresponding to the triple is sent to the attention mechanism AttnNet( ). A maximum value output by AttnNet( ) is selected, to select a feature triple that has a greatest influence on a node feature. The feature triple is sent to the MLP module (the fifth MLP) together with the node feature, to obtain an updated node feature.

For the relationship feature, a forward propagation mode is as follows:

$${e}_{ij}^{l + 1} = {g}_{e} ( [ {v}_{i} , {e}_{ij} , {v}_{j} ] )$$

gₑ( ) refers to the third MLP.

The attention mechanism (AttnNet) uses a query matrix Q whose dimension is d_{q} and a target T whose dimension is d_{τ} as inputs. The attention mechanism predicts an attention weight by using the MLP and performs normalization by using a sigmoid function, to estimate a weight distribution matrix. The weight distribution matrix and the target T are element-wise multiplied, to obtain a final output. A formula of the attention mechanism is as follows:

$$Attn ( Q , T ) = softmax ( {g}_{a} ( Q ) ) ⊙ T$$

⊙ represents an element-wise multiplication operation, and gₐ( ) refers to an MLP (the fourth MLP).

On this basis, a multi-head attention (MAttn) mechanism is also added, to increase flexibility of graph reasoning. The foregoing Q and T matrices are split into h independent attention heads, that is, Q=[q₁, . . . , qₕ] and T=[τ₁, . . . , τₕ]. For i∈[1,h], a dimension of qᵢ is d_{q}/h, and a dimension of τᵢ is d_{τ}/h. Each attention head uses the foregoing attn mechanism, and output results of the h attention heads are concatenated into an output. A formula of the MAttn mechanism is as follows:

$$M Attn ( Q , T ) = {\sum }_{i = l}^{h} [ Attn ( {q}_{i} , {τ}_{i} ) ]$$

In general, a used attention network (AttnNet) generates the query matrix Q from two feature vectors of vᵢ and eᵢⱼ by using a single-layer perceptron (SLP), and generates the target T from the feature vector vⱼ. An MAttn operation is performed on the two matrices Q and T, to obtain a module output. A formula of the AttnNet mechanism is as follows:

$$AttnNet ( {v}_{i} , {e}_{ij} , {v}_{j} ) = MAtnn ( [ {g}_{q} ( {v}_{i} ) , {g}_{e} ( {e}_{ij} ) ] , {g}_{τ} ( {v}_{j} ) )$$

g_{q}( ), gₑ( ), and g_{τ}( ) are respectively an SLP, and are responsible for mapping three features of vᵢ, eᵢⱼ, vⱼ to three dimensions of d_{q}/2, d_{q}/2, and d_{τ}; and [ ] is a concatenation operation. A quantity of attention heads used in the present disclosure is 8.

S4: Determine the 3DSSG of the target scene according to the updated object feature and the updated object relationship feature by using the scene graph generation module, where the scene graph generation module includes a first linear layer, a first batch normalization layer, a first Relu activation function layer, a second linear layer, a second batch normalization layer, a second Relu activation function layer, and a third linear layer that are connected in sequence.

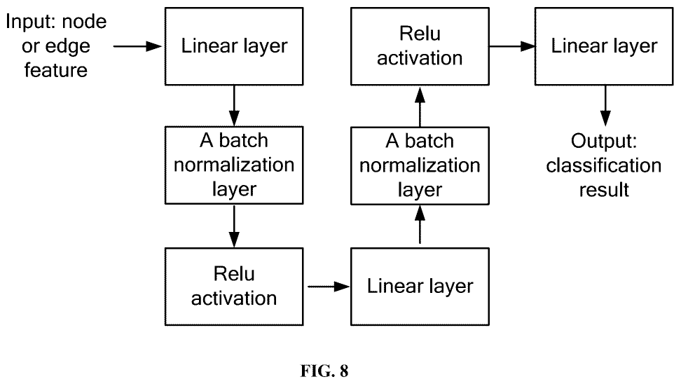

A structure of the scene graph generation module is shown in FIG. 8. An input of the module is the updated object features v; and vᵢ and the updated object relationship feature e′ᵢⱼ by using a graph NN-based graph reasoning module.

These features are organized into a feature triple {v′ᵢ, e′ᵢⱼ, v′ⱼ}according to an object adjacency relationship, to correspond to a relationship triple {oᵢ, rᵢⱼ, oⱼ}. Object and relationship classifiers implemented based on an MLP predict, from the feature triple {v′ᵢ,rᵢⱼ,v′ⱼ}, the semantic relationship triple {oᵢ, rᵢⱼ, oⱼ}. Implementation of the two classifiers is exactly the same. Both of the two classifiers include two full connection layers, and respectively outputs prediction classification probability distribution of an object and prediction classification probability distribution of a relationship. A main function of the full connection layer is to perform linear combination and weighted summation on features at a previous layer, and perform non-linear mapping by using a non-linear activation function, so that an NN can learn and represent a more complex function relationship.

All predicted semantic relation triples form the 3DSSG. These relationship triples are finally constructed as the 3DSSG G=(N, E). Therefore, the semantic understanding task of the 3D point cloud scene is completed.

The 3DSSG prediction model of the present disclosure is obtained by training and verifying a 3D scene graph dataset 3DSSG. The data has a series of 3D scenes including individual object point clouds, and has semantics of an object and semantics of a relationship between objects. Accurately, point clouds of the entire scene, object masks, semantics of each object, and semantics of a relationship between each pair of objects are included.

In comparison with the conventional technology, an advantage of the present disclosure is that classification accuracy of an object in a scene is high. A benchmark test is performed on the dataset, and this conclusion is validated. To assess a prediction result of an object-to-relationship, the result is measured by using top-k accuracy (A@k). In a classification task, accuracy refers to a quantity of samples that are correctly classified to a total quantity of samples. The top-k accuracy is an indicator that measures classification task performance, and refers to, in a model prediction result, a probability that a true classification is included in first K categories with most confidence.

Under a limitation that only 3D point cloud data is used as an input, the method in the present disclosure improves an object classification indicator A@1 by 6.6% compared with a current state-of-the-art model Spatial-Gate Feed-forward Network (SGFN). This experimental result proves validity and superiority of the method proposed in the present disclosure. A specific technical effect of the method of the present disclosure is shown in Table 1, where the SGPN model is a first point cloud-based 3D scene graph generation model, and the SGFN model is a current advanced model.

TABLE 1
Performance comparison table of each model on a 3DSSG dataset

| | | | |
|---|---|---|---|
| Models | SGPN | SGFN | This method |

| | | | | |
|---|---|---|---|---|
| Object | A@1 | 48.28 | 53.67 | 60.25 |
| | A@5 | 72.94 | 77.18 | 82.19 |
| | A@10 | 82.74 | 85.14 | 88.80 |
| Relationship | A@1 | 91.32 | 90.19 | 90.19 |
| | A@3 | 98.09 | 98.17 | 98.32 |
| | A@5 | 99.15 | 99.33 | 99.46 |
| | mA@1 | 32.01 | 41.89 | 46.57 |
| | mA@3 | 55.22 | 70.82 | 70.52 |
| | mA@5 | 69.44 | 81.44 | 86.29 |
| Triple | A@50 | 87.55 | 89.02 | 90.55 |
| | mA@50 | 41.52 | 58.37 | 65.86 |
| | A@100 | 90.66 | 91.71 | 93.10 |
| | mA@100 | 51.92 | 67.61 | 75.17 |

This advantage mainly comes from S2 and S3. A Transformer is a current advanced model method in the field of artificial intelligence. In addition, in comparison with another feature extraction manner, this method has a larger parameter quantity, and can fit a more complex mapping relationship, and a unique self-attention mechanism of the method can learn a key point of input data. The graph NN-based graph reasoning module (the graph NN-based relationship reasoning module) has a powerful graph structure reasoning capability, and can be well applied to applications such as a knowledge map and a social network. A powerful feature extraction capability of the Transformer and a powerful graph structure reasoning capability of a graph NN enable the present disclosure to achieve higher object classification prediction accuracy. In an ablation experiment, the Transformer-based object feature extraction module and the graph NN-based graph reasoning module are respectively abandoned, and all obtained precision indexes are not as ideal as this method. Specific conditions of the ablation experiment are shown in Table 2 and Table 3.

TABLE 2
Performance comparison table on a 3DSSG dataset
using different feature extractors

| | | |
|---|---|---|
| Object feature | | Transformer |
| extraction manner | PointNet | (this method) |

| | | | |
|---|---|---|---|
| Object | A@1 | 56.88 | 60.25 |
| | A@5 | 79.95 | 82.19 |
| | A@10 | 87.78 | 88.80 |
| Relationship | A@1 | 91.14 | 90.19 |
| | A@3 | 98.45 | 98.32 |
| | A@5 | 99.46 | 99.46 |
| | mA@1 | 45.60 | 46.57 |
| | mA@3 | 68.91 | 70.52 |
| | mA@5 | 81.51 | 86.29 |
| Triple | A@50 | 90.53 | 90.55 |
| | mA@50 | 62.85 | 65.86 |
| | A@100 | 93.16 | 93.10 |
| | mA@100 | 73.76 | 75.17 |

TABLE 3
Ablation experiment table for a graph
NN-based graph reasoning module

| | | |
|---|---|---|
| Whether to use a graph | | Yes |
| reasoning module | No | (this method) |

| | | | |
|---|---|---|---|
| Object | A@1 | 57.89 | 60.25 |
| | A@5 | 80.42 | 82.19 |
| | A@10 | 87.33 | 88.80 |
| Relationship | A@1 | 91.12 | 90.19 |
| | A@3 | 98.03 | 98.32 |
| | A@5 | 99.38 | 99.46 |
| | mA@1 | 47.78 | 46.57 |
| | mA@3 | 67.24 | 70.52 |
| | mA@5 | 80.07 | 86.29 |
| Triple | A@50 | 90.58 | 90.55 |
| | mA@50 | 53.63 | 65.86 |
| | A@100 | 93.20 | 93.10 |
| | mA@100 | 64.41 | 75.17 |

### Embodiment 2

To perform the method corresponding to Embodiment 1 and achieve corresponding functions and technical effects, a 3DSSG generation system is provided below, including:
a data obtaining module configured to obtain a point cloud set and an object segmentation result of a target scene, where the target scene includes multiple objects;
an object point cloud subset determining module configured to determine a point cloud subset of each object according to the point cloud set and the object segmentation result; and
a scene graph prediction module configured to determine a 3DSSG of the target scene according to a point cloud subset of any object and object auxiliary information by using a 3DSSG prediction model, where the object auxiliary information includes a bounding box size of the point cloud subset, an object length, an object volume, and an object point cloud spatial distribution SD; the 3DSSG prediction model is obtained by training a 3DSSG initial prediction model by using a training dataset; the training dataset is a 3DSSG dataset; the 3DSSG prediction model includes a Transformer-based feature extractor, a first MLP, a graph NN-based relationship reasoning module, and a scene graph generation module; both the Transformer-based feature extractor and the first MLP are connected to the graph NN-based relationship reasoning module; and the graph NN-based relationship reasoning module is connected to the scene graph generation module.

### Embodiment 3

The present disclosure provides an electronic device, including a memory and a processor, the memory is configured to store a computer program, and the processor runs the computer program to enable the electronic device to perform the 3DSSG generation method in Embodiment 1.

In an optional implementation, the memory is a readable storage medium.

Each embodiment in the description is described in a progressive mode, each embodiment focuses on differences from other embodiments, and references can be made to each other for the same and similar parts between embodiments. Since the system disclosed in an embodiment corresponds to the method disclosed in an embodiment, the description is relatively simple, and for related contents, references can be made to the description of the method.

Particular examples are used herein for illustration of principles and implementation modes of the present disclosure. The descriptions of the above embodiments are merely used for assisting in understanding the method of the present disclosure and its core ideas. In addition, those of ordinary skill in the art can make various modifications in terms of particular implementation modes and the scope of application in accordance with the ideas of the present disclosure. In conclusion, the content of the description shall not be construed as limitations to the present disclosure.

What is claimed is:

1. A three-dimensional semantic scene graph (3DSSG) generation method, comprising:
obtaining a point cloud set and an object segmentation result of a target scene, wherein the target scene comprises multiple objects;
determining a point cloud subset of each object according to the point cloud set and the object segmentation result; and
determining a 3DSSG of the target scene according to a point cloud subset of any object and object auxiliary information by using a 3DSSG prediction model, wherein the object auxiliary information comprises a bounding box size of the point cloud subset, an object length, an object volume, and an object point cloud spatial distribution standard deviation (SD); the 3DSSG prediction model is obtained by training a 3DSSG initial prediction model by using a training dataset; the training dataset is a 3DSSG dataset; the 3DSSG prediction model comprises a Transformer-based feature extractor, a first multi-layer perceptron (MLP), a graph neural network (NN)-based relationship reasoning module, and a scene graph generation module; both the Transformer-based feature extractor and the first MLP are connected to the graph NN-based relationship reasoning module; and the graph NN-based relationship reasoning module is connected to the scene graph generation module.

2. The 3DSSG generation method according to claim 1, wherein the determining a 3DSSG of the target scene according to a point cloud subset of any object and object auxiliary information by using a 3DSSG prediction model specifically comprises:
determining an object feature of the any object according to the point cloud subset of the any object and the object auxiliary information by using the Transformer-based feature extractor, wherein the Transformer-based feature extractor comprises a second MLP, a first Transformer module, a downsampling layer, and a second Transformer module that are connected in sequence;
determining an object relationship feature according to a point cloud subset of a source object and a point cloud subset of a target object by using the first MLP, wherein the source object and the target object are two related objects in the target scene;
updating the object feature and the object relationship feature by using the graph NN-based relationship reasoning module, to obtain an updated object feature and an updated object relationship feature, wherein the graph NN-based relationship reasoning module comprises a relationship feature updating module and an object feature updating module; the relationship feature updating module is a third MLP; and the object feature updating module is an attention network (AttnNet); and
determining the 3DSSG of the target scene according to the updated object feature and the updated object relationship feature by using the scene graph generation module, wherein the scene graph generation module comprises a first linear layer, a first batch normalization layer, a first rectified linear unit (Relu) activation function layer, a second linear layer, a second batch normalization layer, a second Relu activation function layer, and a third linear layer that are connected in sequence.

3. The 3DSSG generation method according to claim 2, wherein the first Transformer module comprises a fourth linear layer, a first Transformer layer, and a fifth linear layer that are connected in sequence.

4. The 3DSSG generation method according to claim 2, wherein the second Transformer module comprises a sixth linear layer, a second Transformer layer, and a seventh linear layer that are connected in sequence.

5. The 3DSSG generation method according to claim 2, wherein the AttnNet comprises a sixth linear layer, a seventh linear layer, an eighth linear layer, a fourth MLP, a softmax function layer, and a fifth MLP; and
both the sixth linear layer and the seventh linear layer are connected to the fourth MLP; the fourth MLP is connected to the softmax function layer; and both the softmax function layer and the eighth linear layer are connected to the fifth MLP.

6. A 3DSSG generation system, comprising:
a data obtaining module configured to obtain a point cloud set and an object segmentation result of a target scene, wherein the target scene comprises multiple objects;
an object point cloud subset determining module configured to determine a point cloud subset of each object according to the point cloud set and the object segmentation result; and
a scene graph prediction module configured to determine a 3DSSG of the target scene according to a point cloud subset of any object and object auxiliary information by using a 3DSSG prediction model, wherein the object auxiliary information comprises a bounding box size of the point cloud subset, an object length, an object volume, and an object point cloud spatial distribution SD; the 3DSSG prediction model is obtained by training a 3DSSG initial prediction model by using a training dataset; the training dataset is a 3DSSG dataset; the 3DSSG prediction model comprises a Transformer-based feature extractor, a first MLP, a graph NN-based relationship reasoning module, and a scene graph generation module; both the Transformer-based feature extractor and the first MLP are connected to the graph NN-based relationship reasoning module; and the graph NN-based relationship reasoning module is connected to the scene graph generation module.

7. An electronic device, comprising a memory and a processor, wherein the memory is configured to store a computer program, and the processor runs the computer program to enable the electronic device to perform the 3DSSG generation method according to claim 1.

8. The electronic device according to claim 7, wherein the determining a 3DSSG of the target scene according to a point cloud subset of any object and object auxiliary information by using a 3DSSG prediction model specifically comprises:
determining an object feature of the any object according to the point cloud subset of the any object and the object auxiliary information by using the Transformer-based feature extractor, wherein the Transformer-based feature extractor comprises a second MLP, a first Transformer module, a downsampling layer, and a second Transformer module that are connected in sequence;
determining an object relationship feature according to a point cloud subset of a source object and a point cloud subset of a target object by using the first MLP, wherein the source object and the target object are two related objects in the target scene;
updating the object feature and the object relationship feature by using the graph NN-based relationship reasoning module, to obtain an updated object feature and an updated object relationship feature, wherein the graph NN-based relationship reasoning module comprises a relationship feature updating module and an object feature updating module; the relationship feature updating module is a third MLP; and the object feature updating module is an attention network (AttnNet); and
determining the 3DSSG of the target scene according to the updated object feature and the updated object relationship feature by using the scene graph generation module, wherein the scene graph generation module comprises a first linear layer, a first batch normalization layer, a first rectified linear unit (Relu) activation function layer, a second linear layer, a second batch normalization layer, a second Relu activation function layer, and a third linear layer that are connected in sequence.

9. The electronic device according to claim 8, wherein the first Transformer module comprises a fourth linear layer, a first Transformer layer, and a fifth linear layer that are connected in sequence.

10. The electronic device according to claim 8, wherein the second Transformer module comprises a sixth linear layer, a second Transformer layer, and a seventh linear layer that are connected in sequence.

11. The electronic device according to claim 8, wherein the AttnNet comprises a sixth linear layer, a seventh linear layer, an eighth linear layer, a fourth MLP, a softmax function layer, and a fifth MLP; and
both the sixth linear layer and the seventh linear layer are connected to the fourth MLP; the fourth MLP is connected to the softmax function layer; and both the softmax function layer and the eighth linear layer are connected to the fifth MLP.

12. The electronic device according to claim 7, wherein the memory is a readable storage medium.

13. The electronic device according to claim 8, wherein the memory is a readable storage medium.

14. The electronic device according to claim 9, wherein the memory is a readable storage medium.

15. The electronic device according to claim 10, wherein the memory is a readable storage medium.

16. The electronic device according to claim 11, wherein the memory is a readable storage medium.
